(19) United States
(12) Patent Application Publication
(10) Pub. No.: US 2015/0213274 A1
(43) Pub. Date: Jul. 30, 2015

(54) DEVICE AND METHOD OF SHIELDING REGION OF DISPLAY SCREEN

(71) Applicant: SAMSUNG ELECTRONICS CO., LTD., Suwon-si (KR)

(72) Inventors: Yanjun XU, Beijing (CN); Bin JU, Beijing (CN); Chunhuan HAO, Beijing (CN); Shihu CHENG, Beijing (CN); Shunchang PEI, Beijing (CN); Ming LI, Beijing (CN); Yi ZHAO, Beijing (CN); Yongxuan ZHU, Beijing (CN)

(73) Assignee: SAMSUNG ELECTRONICS CO., LTD., Suwon-si (KR)

(21) Appl. No.: 14/608,635

(22) Filed: Jan. 29, 2015

(30) Foreign Application Priority Data
Jan. 29, 2014 (CN) 201410042900.2
Mar. 3, 2014 (CN) 201410074655.3
Jan. 16, 2015 (KR) 10-2015-0008254

(51) Int. Cl. G06F 21/60; G06F 3/0484; G06F 3/0481

(52) U.S. Cl. CPC G06F 21/60; G06F 3/0481; G06F 3/04842

(57) ABSTRACT

A device and a method of shielding a region of a display screen in the device are provided. The method includes: acquiring at least one of shield information of an application executed in the device, and a shielding operation performed by a user to shield the region of the display screen; and shielding the region of the display screen based on the acquired at least one of the shield information and the shielding operation.

### CROSS-REFERENCE TO RELATED APPLICATIONS

This application claims priority from Korean Patent Application No. 10-2015-0008254, filed on Jan. 16, 2015 in the Korean Intellectual Property Office, Chinese Patent Application No. 201410042900.2, filed on Jan. 29, 2014 in the State Intellectual Property Office of the People's Republic of China, and Chinese Patent Application No. 201410074655.3, filed on Mar. 3, 2014, in the State Intellectual Property Office of the People's Republic of China, the disclosures of which are incorporated herein in their entireties by reference.

### BACKGROUND

1. Field

Apparatuses and methods consisting with exemplary embodiments relate to shielding all or a region of a display screen.

2. Description of the Related Art

Recently, with the rapid development of the electronics industry and communication technology, new services based on data, voice and video are rapidly developing. The rapid development of micro-electronic technology and computer hardware and software technology provides a basis for terminals for processing more complex work, and eliminates network restrictions so that the terminals may have powerful functions. Also, the development of information technology may lead to intelligent, mobile, and multi-functional terminals.

In order to provide convenience to users and enhanced visual effects, a device such as a mobile phone may have a large screen. Due to the large screen, information may easily be exposed when the device is used in public. To prevent information exposure, methods such as data encryption, data saving by permission, screen savers, and screen lock are being used. However, since these methods are performed on an entire screen of the device, which is larger than a region of information to be shielded, a normal use of the device may be affected.

### SUMMARY

Aspects of one or more exemplary embodiments provide a method of shielding all or a region of a display screen, a device performing the method, and a non-transitory computer-readable recording medium having recorded thereon a program, which, when executed by a computer, performs the method.

Additional aspects will be set forth in part in the description which follows and, in part, will be apparent from the description, or may be learned by practice of exemplary embodiments.

According to an aspect of an exemplary embodiment, there is provided a method of shielding a region of a display screen in a device, the method including: acquiring at least one of shield information of an application executed in the device, and a shielding operation performed by a user to shield the region of the display screen; and shielding the region of the display screen based on the acquired at least one of the shield information and the shielding operation.

The shielding the region of the display screen may include: selecting a region of the display screen according to the acquired at least one of the shield information and the shielding operation; and shielding the selected region.

The shielding the selected region may include shielding a display image corresponding to the selected region.

The shielding the display image corresponding to the selected region may include displaying a shield window, which is fixedly synchronized with the display screen, on the selected region.

The shield window may be moved within the display screen based on an operation of the user.

The shielding the selected region may include shielding a content included in the selected region.

The shielding the content may include displaying a shield window for shielding the content, which is synchronized with the content, on the selected region.

The shielding the region of the display screen may include modifying a display image of the region on the display screen.

The method may further include: acquiring at least one of the shield information and a clearing operation performed by the user to completely or partially clear a shield region of the display screen; and displaying a content included in all or a portion of the shield region of the display screen based on the acquired at least one of the shield information and the clearing operation.

The displaying the content may include: selecting a clearing region from the shield region of the display screen, based on the acquired at least one of the clearing operation of the user and the shield information; and displaying a content included in the selected clearing region.

According to an aspect of another exemplary embodiment, there is provided a non-transitory computer-readable recording medium having recorded thereon a program, which, when executed by a computer, performs the method.

According to an aspect of another exemplary embodiment, there is provided a device for shielding a region of a display screen, the device including: an input unit configured to acquire at least one of shield information of an application executed in the device, and a shielding operation performed by a user to shield the region of the display screen; a controller configured to select the region of the display screen based on the acquired at least one of the shield information and the shielding operation; and a display configured to shield the selected region.

The display may be further configured to shield a display image corresponding to the selected region.

The display may be further configured to display a shield window, which is fixedly synchronized with the display screen, on the selected region.

The shield window may be moved within the display screen based on an operation of the user.

The display may be further configured to shield a content included in the selected region.

The display may be further configured to display a shield window for shielding the content, which is synchronized with the content, on the selected region.

The input unit may be further configured to acquire at least one of the shield information and a clearing operation performed by the user to completely or partially clear a shield region of the display screen, the controller may be further configured to select a clearing region from the shield region of the display screen, based on the acquired at least one of the shield information and the clearing operation of the user, and the display may be further configured to display a content included in the selected clearing region.

The controller may be further configured to verify the acquired at least one of the shield information and the clearing operation, and the display may be further configured to display the content when the verification is successful.

The input unit may be further configured to acquire sight focus information of the user, and the controller may be further configured to select the clearing region as a region corresponding to a sight focus of the user based on the acquired sight focus information of the user.

According to an aspect of another exemplary embodiment, there is provided a device for shielding a region of a display screen, the device including: a controller configured to: select the region of the display screen based on an acquired at least one of shield information of an application executed in the device, and a shielding operation performed by a user to shield the region of the display screen; and shield the selected region of the display screen and output the display screen in which the selected region is shielded.

The controller may be further configured to shield a display image, of the display screen, corresponding to the selected region.

The controller may be further configured to output a shield window, which is fixedly synchronized with the display screen on the selected region.

The shield window may be moved within the display screen based on an operation of the user.

The controller may be further configured to shield a content included in the selected region.

The controller may be further configured to output a shield window for shielding the content, which is synchronized with the content in the selected region.

The controller may be further configured to: select a clearing region from the shield region of the display screen, based on an acquired at least one of the shield information and a clearing operation performed by the user to completely or partially clear a shield region of the display screen; and control to output for display a content included in the selected clearing region.

The controller may be further configured to: verify the acquired at least one of the shield information and the clearing operation; and control to output for display the content when the verification is successful.

The controller may be further configured to select the clearing region as a region corresponding to a sight focus of the user based on acquired sight focus information of the user.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a diagram for describing a method of shielding all or a region of a display screen on a device according to an exemplary embodiment;

FIG. 2 is a flowchart of a method of shielding all or a region of a display screen on a device according to an exemplary embodiment;

FIG. 3 is a diagram for describing a method of shielding all or a region of a display screen on a device according to an exemplary embodiment;

FIG. 4 is a diagram for describing a process of moving a shield window on the device of FIG. 3;

FIG. 5 is a diagram of a shield window that shields all or a region of a display screen on the device of FIG. 3;

FIG. 6 is a diagram for describing a method of shielding all or a region of a display screen on a device according to another exemplary embodiment;

FIG. 7 is a diagram of a shield window that shields all or a region of a display screen on the device of FIG. 6;

FIG. 8 is a diagram of a shield window that shields all or a region of a display screen on a device according to another exemplary embodiment;

FIG. 9 is a diagram for describing a method of shielding all or a region of a display screen on a device according to an exemplary embodiment;

FIG. 10 is a flowchart of a method of shielding all or a region of a display screen on a device according to another exemplary embodiment;

FIG. 11 is a diagram for describing a process of shielding all or a region of a display screen or clearing a shield on the display screen according to the method of shielding all or a region of the display screen of FIG. 10;

FIG. 12 is a block diagram of an exemplary structure of a device that shields all or a region of the display screen of FIG. 1; and

FIG. 13 is a block diagram of another exemplary structure of a device that shields all or a region of the display screen of FIG. 1.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout. In this regard, exemplary embodiments may have different forms and should not be construed as being limited to the descriptions set forth herein. Accordingly, exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, exemplary embodiments will be described more fully with reference to the accompanying drawings. Exemplary embodiments may have different forms and should not be construed as being limited to the descriptions set forth herein.

The terms used in the present specification and claims should not be understood by their ideal or literal meanings, but by meanings that correspond to the scope of the inventive concept.

Throughout the specification, it will also be understood that when an element is referred to as being “connected to” another element, it can be directly connected to the other element, or electrically connected to the other element while intervening elements may also be present. Also, when a part “includes” or “comprises” an element, unless there is a particular description contrary thereto, the part can further include other elements, not excluding the other elements.

In the present specification, the term “content” refers to an object that is displayed on a display screen and may be selected according to a user input. The content includes images, text, and videos, and may include icons, link information, replay videos, background images, unlock screens, and keyboard images.

The term “tap” refers to quickly touching a screen with a finger or a stylus of a user. In other words, “tap” refers to a case where a difference between a touch-in time (when the finger of the stylus contacts the screen) and a touch-out time (when the finger or the stylus is detached from the screen) is very small and less than a predetermined time.

The term “touch and hold” refers to touching the screen with the finger or the stylus of the user and maintaining the touch input for a predetermined time or more. In other words, “touch and hold” refers to a case where a difference between a touch-in time and a touch-out time is equal to or greater than a predetermined time. A visual or an auditory feedback signal may be provided when a touch input is maintained for a predetermined time or longer so that the user may recognize whether the touch input is “tap” or “touch and hold.”

The term “double tap” refers to quickly touching the screen twice with the finger or the stylus of the user. For example, the term “double tap” may refer to successive “taps” whereby the difference in time between the “taps” is less than a predetermined time.

The term “hovering” refers to proximity touching a space near a screen with the finger or the stylus of the user. In other words, “hovering” refers to a case where the finger or the stylus is located within a predetermined distance from the screen.

The term “drag” refers to touching the screen with the finger or the stylus of the user and moving the finger or the stylus to another location while touching the screen. The “drag” may include a sliding operation.

The term “flick” refers to quickly dragging with the finger or the stylus of the user. The “drag” and “flick” may be distinguished based on whether a moving speed of the finger or the stylus is equal to or greater than a predetermined speed.

The term “pinch” refers to touching the screen with a plurality of fingers or a plurality of styluses of the user and increasing or reducing intervals between the fingers or the styluses. After touching the screen with the thumb and the index finger of the user, an operation of increasing intervals between the thumb and the index finger is referred to as “unpinching,” and an operation of reducing the intervals is referred to as “pinching.” For example, a page may be zoomed in by an unpinching input and zoomed out by a pinching input.

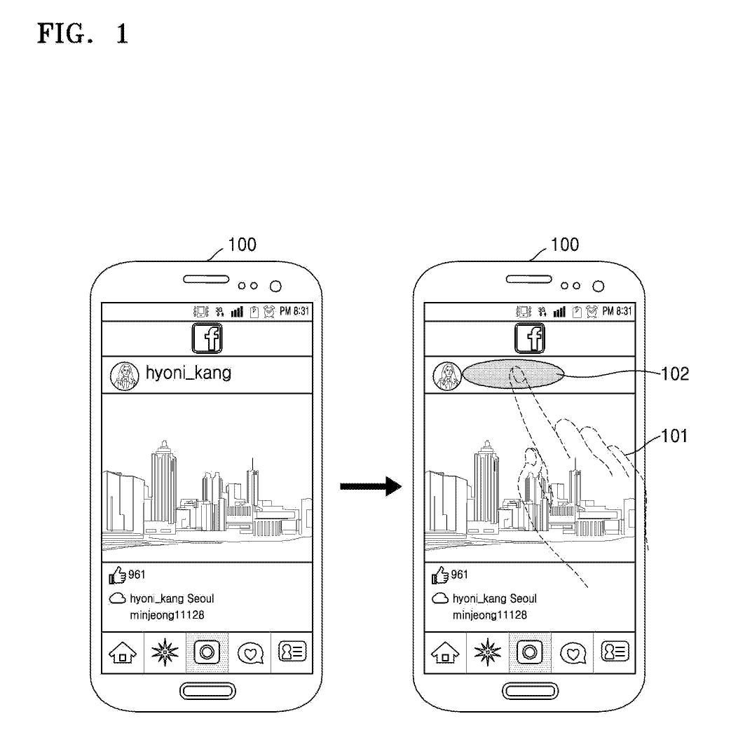

FIG. 1 is a diagram for describing a method of shielding all or a region of a display screen on a device 100 according to an exemplary embodiment.

Referring to FIG. 1, the device 100 may display a display screen that includes a predetermined content, and shield (e.g., shield from exposure) a region of (i.e., all or a portion of) the display screen based on an operation of a user or preset information. According to exemplary embodiments, when shielding all of the display screen, the device 100 does not turn off the display screen or change the screen to a different application (e.g., a home screen).

In detail, the device 100 may shield a portion of the display screen corresponding to the certain region or a content included in the certain region to protect the certain region of the display screen from exposure. For example, the device 100 may display a predetermined image or a shield window in the certain region of the display screen.

Also, in order to shield all or a region of the display screen, the device 100 may modify a display image of a content included in all or a region of the display screen. For example, the device 100 may display the content in a blurry, dark, or transparent manner, or display the content as a mosaic.

Even when the device 100 is used in a public place, the user may use a display screen shielding function of the device 100 to prevent an exposure of personal information of the user or information of a content used by the user. Also, the user may avoid watching unwanted contents, such as harmful information or advertisements.

Referring to FIG. 1, the device 100 may execute an application and display an image or content of the application. For example, when the user executes a social network service (SNS) application, the device 100 may display an execution window of the SNS application. Then, in order to shield account information of the user included in a window of the SNS application, the user may use a finger 101 or a stylus to tap a certain region of a display screen which displays the account information of the user. The device 100 may shield the certain region of the display screen which corresponds to the tapping operation of the user. For example, the device 100 may select (e.g., determine, designate, indicate, or obtain) a certain region that corresponds to an operation of the user and display a shield window 102 in the selected region.

The shield window 102 may be an additional window including a predetermined image or text. The predetermined image or text may be preset by default or set by the user. Also, the shield window 102 may be a mosaic or semi-transparent window. The shield window 102 may be synchronously displayed with the display screen or a content included in the certain region of the display screen.

The shield window 102 synchronized to the display screen may indicate that a location of the shield window 102 is fixed on the display screen and thus is not affected by a change in a window of an application, such as scrolling. Also, the shield window 102 being synchronized with the content may indicate that a location of the shield window 102 is fixed to the content or to the window of the application and thus the shield window 102 moves as the content or the window of the application is moved in the display screen.

The shield window 102 may or may not affect a normal operation of a shield region. For example, when the shield window 102 is set to affect the normal operation of the shield region, the shield region shielded by the shield window 102 may not be selected even when the user touches, taps, or otherwise manipulates the shield region. However, when the shield window 102 is set to not affect the normal operation of the shield region, a content in the shield region may be selected when the user touches the shield region shielded by the shield window 102. Although the user may not see the content in the shield region, the user may use the device 100 in the same manner as when the content is seen.

Also, when an application is executed, the device 100 may shield all or a region of the display screen based on shield information (e.g., previously set or default shield information) of the executed application.

Shield information of an application includes a shield state of a display screen with respect to a displayed window of the application. In detail, the shield information may include at least one of a method of shielding a certain region of the display screen, a method of clearing a shield, and an object to be synchronized with a shield window. For example, based on the shield information, the device 100 may shield the display screen by determining at least one of an extent and a location of a shield region, a shape of the shield window, and a shielding time, which correspond to the window of the application.

In detail, when an SNS application is executed, the device 100 may acquire (e.g., from memory or from the application) shield information of the SNS application. The device 100 may select a region of a display screen based on the acquired shield information, and display the shield window 102 in the selected region. The device 100 may automatically shield the display screen when the SNS application is executed, by using preset shield information of the application.

The device 100 may acquire shield information when an application is executed and automatically shield a display screen. Alternatively, the device 100 may use shield information when a shielding operation of the user is acquired after the application is executed, and shield the display screen.

The device 100 according to an exemplary embodiment may be an electronic device including a display screen, for example, a smart phone, a mobile phone, a tablet, a netbook, a portable multimedia player, a personal digital assistant, a wearable smart device, a digital TV, a kiosk, a Personal Digital Assistant (PDA), a laptop, a media player, a Global Positioning System (GPS) device, or other mobile or non-mobile computing devices. However, the device 100 is not limited thereto, and may include various devices that may receive a touch input, for example, an electronic blackboard and a touch table.

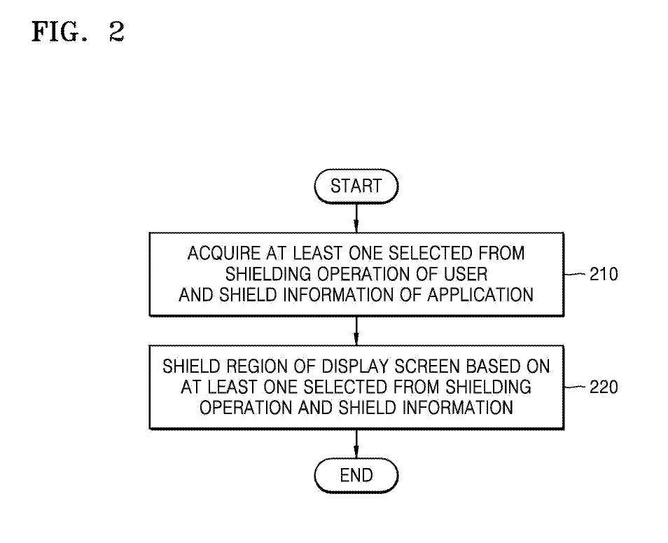

FIG. 2 is a flowchart of a method of shielding all or a region of a display screen on the device 100 according to an exemplary embodiment.

Referring to FIG. 2, in operation 210, the device 100 may acquire at least one of an operation performed by the user to shield a certain region of a display screen, and shield information of an application executed in the device 100.

The device 100 may acquire a shielding operation from the user. For example, the device 100 may acquire (e.g., obtain) the shielding operation by detecting a predetermined manipulation by the user, e.g., tapping, touching and holding, double tapping, hovering, dragging, or flicking performed by the finger or the stylus of the user. Alternatively, the device 100 may acquire the shielding operation by detecting an operation of wiping the display screen by using an eraser image displayed on the display screen or an operation of positioning a cursor in a textbox.

Furthermore, when the application is executed, the device 100 may acquire the shield information of the executed application. By using the acquired shield information, the device 100 may automatically shield the display screen when the application is executed or shield the display screen when the shielding operation of the user is acquired after the application is executed.

In operation 220, the device 100 may shield all or a region of the display screen based on at least one of the acquired shielding operation and the acquired shield information of the application.

The device 100 may select a certain region to be shielded in the display screen based on the acquired shielding operation. For example, based on a dragging operation performed by the user, the device 100 may select a region from a drag start point to a drag end point as a region to be shielded.

According to another example, based on a tapping operation performed by the user, the device 100 may select a predetermined region around a tapping point as a region to be shielded. Additionally, based on a touch and hold operation of the user, the device 100 may select a predetermined region formed around a touch point as a region to be shielded. The predetermined region may include a larger region depending on the holding time

Also, when the user positions a cursor in a textbox, the device 100 may select a text region from an initial location of the cursor to a current location of the cursor as a region to be shielded.

Moreover, the device 100 may select a region to be shielded based on the acquired shield information of the application. The device 100 may store shield information that corresponds to each application, or may store shield information that corresponds to a plurality (or all) applications (e.g., shield information to detect and shield credit card information or user account information in any executed application). The shield information of the application may be preset by default or set by the user.

Also, the device 100 may store information of an object to be shielded as the shield information of the application. For example, the device 100 may store words, expressions, and images which are harmful, banking information, advertisement information, or phone number information as the object to be shielded in the shield information.

In detail, based on prestored information of the object to be shielded, the device 100 may select all or a portion of a content displayed on a display screen as the object to be shielded. The device 100 may completely shield or partially shield a region in which the selected content is located.

For example, when an application is executed and an advertisement is displayed, the device 100 may scan all contents displayed on a display screen, determine whether there is a content including a prestored object (e.g., an advertisement) to be shielded, and select the displayed advertisement as the object to be shielded. The device 100 may completely or partially shield a region in which the advertisement is located, and the user may use the device 100 without being exposed to the advertisement information.

Based on at least one of the acquired shielding operation and the acquired shield information of the application, the device 100 may select all or a region of the display screen as a region to be shielded. The device 100 may select a plurality of regions.

The device 100 may completely or partially shield the display screen by displaying a shield window, such as a predetermined image, on a selected region. Also, the device 100 may completely or partially shield the display screen by modifying a display image of a content included in the selected region.

The device 100 may synchronously display the shield window and the display screen or a content included in all or a region of the display screen.

The device 100 may move the displayed shield window based on an additional operation of the user. For example, when the user touches and drags the shield window, the device 100 may move the shield window to a dragged location and display the shield window.

Also, the device 100 may adjust a shield region where the shield window is displayed or a non-shield region where the content is normally displayed, based on the additional operation of the user. For example, when the user touches and drags a boundary of the shield window, the device 100 may modify the boundary of the shield window and adjust the shield region or the non-shield region.

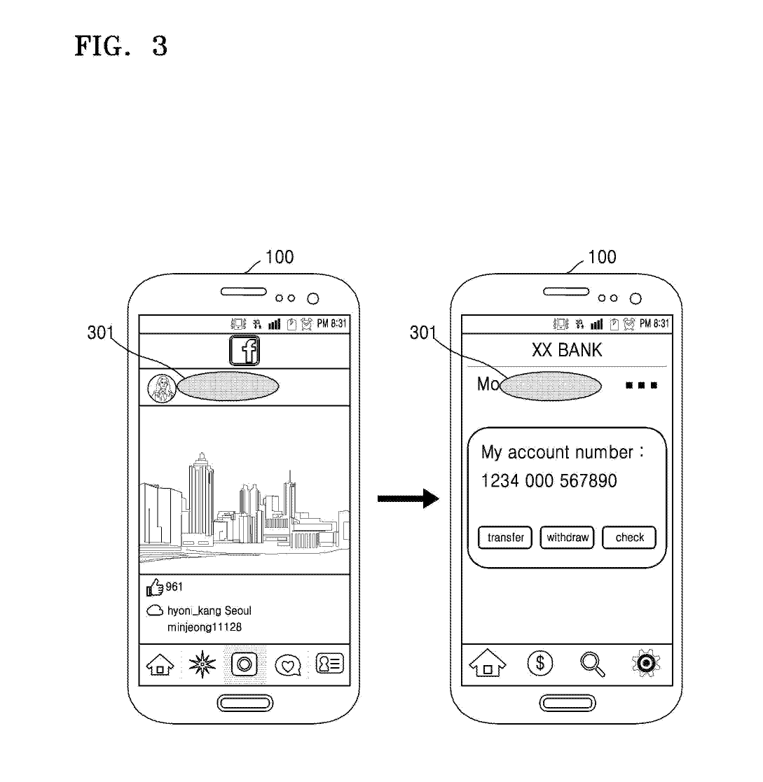

FIG. 3 is a diagram for describing a method of shielding all or a region of a display screen on the device 100 according to an exemplary embodiment.

In FIG. 3, the device 100 may shield a portion of a display screen corresponding to a selected region to protect all or a region of the display screen. In detail, the device 100 may display a shield window 301, which is synchronized with the display screen, on a selected region.

A left image of FIG. 3 shows a display screen of the device 100 displaying a window of a first application, and a right image of FIG. 3 shows a display screen of the device 100 displaying a window of a second application.

In a state where the shield window 301 synchronized with the display screen is displayed, when the window of the first application is converted to the window of the second application, the device 100 may display the shield window 301 at an identical location in the display screen. Also, the device 100 may display the shield window 301 in the same manner even when the window of the first application is closed.

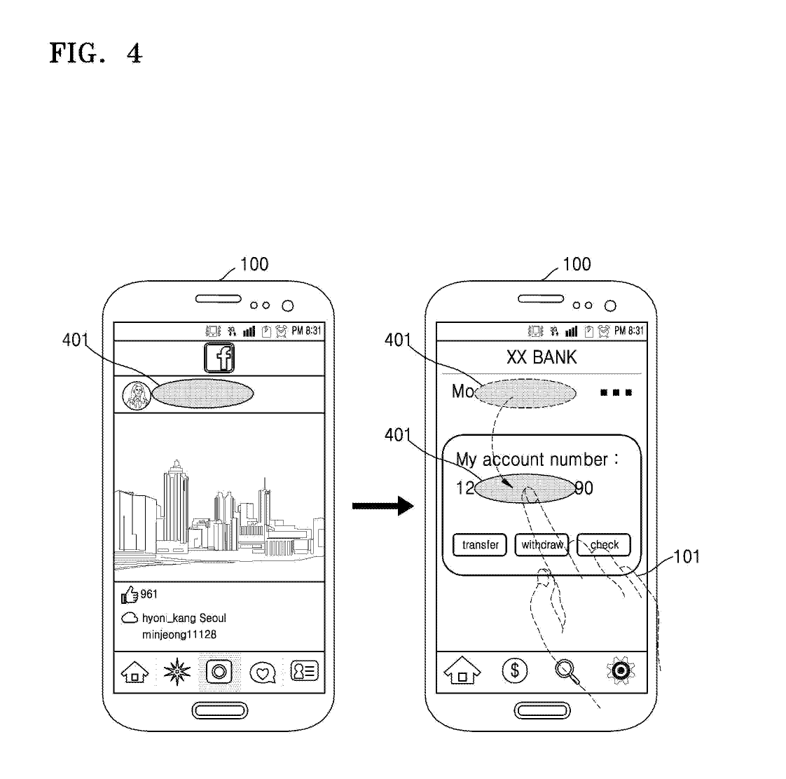

FIG. 4 is a diagram for describing a process of moving a shield window 401 on the device 100 of FIG. 3.

Referring FIG. 4, the device 100 may display the shield window 401 that is synchronized with a display screen. When a window of a first application is converted to a window of a second application, the device 100 display the shield window 401 in an unchanged (i.e., fixed) manner.

The user may prefer different locations for a region to be shielded on the window of the first application and a region to be shielded on the window of the second application. The user may perform a shielding operation and display a new shield window, or alternatively, shield the region to be shielded on the window of the second application by using the shield window 401 that is already being displayed.

In detail, the user may touch and drag the shield window 401 by using the finger or the stylus and move the shield window 401 to another location. The device 100 may receive an additional operation from the user, for example, touching and dragging, and move the shield window 401 to a dragged location based on the additional operation and display the shield window 401.

The device 100 may display the shield window 401 that affects a normal operation of a shield region. In other words, when the user touches the shield window 401, the device 100 may acquire a touch operation with respect to the shield window 401 but may not acquire a touch operation with respect to a shield region (i.e., a shielded region of the application screen) shielded by the shield window 401.

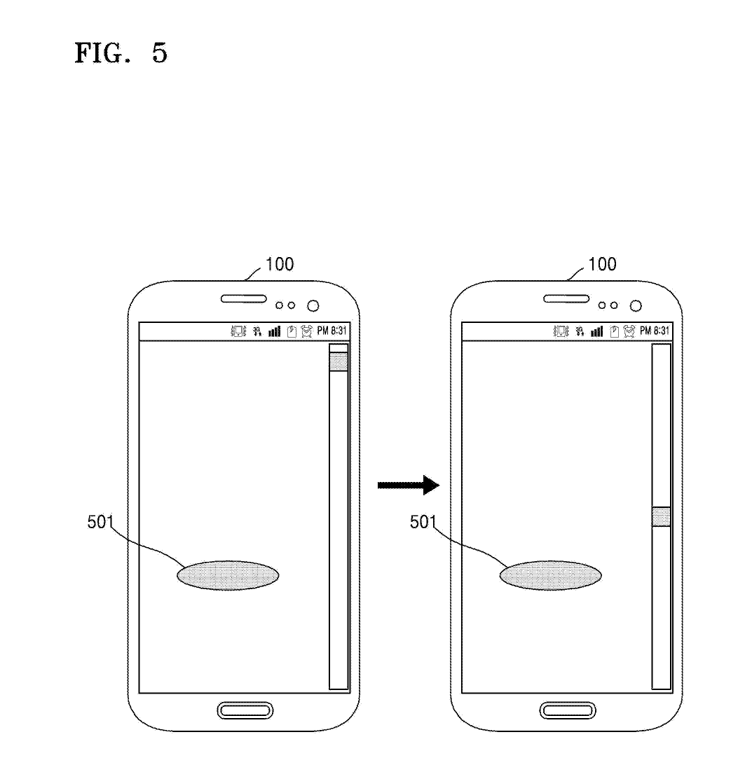

FIG. 5 is a diagram of a shield window 501 that shields all or a region of a display screen on the device 100 of FIG. 3.

Referring to FIG. 5, the device 100 may acquire a shielding operation from the user or shield information of an application, and thus display the shield window 501 for shielding all or a region of the display screen.

The device 100 may display the shield window 501, which is synchronized with the display screen, on a selected region.

When a window displayed on the display screen is scrolled, the device 100 may display the shield window 501 at an identical location in the display screen. Also, the device 100 may display the shield window 501 in an identical size and shape even when a window displayed on the display screen is zoomed in or zoomed out.

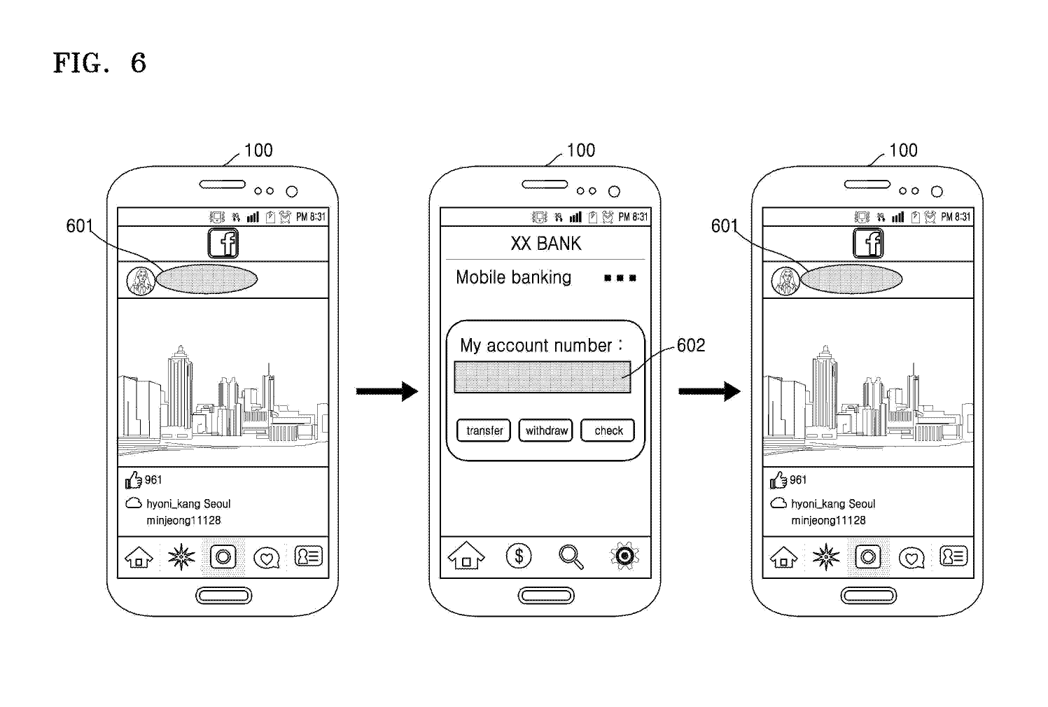

FIG. 6 is a diagram for describing a method of shielding all or a region of a display screen on a device 100 according to another exemplary embodiment.

In FIG. 6, the device 100 may shield a content included in a selected region to completely or partially protect the display screen. In the selected region, the device 100 may display a shield window 601, which is synchronized with the content (e.g., synchronized with the particular application), on the selected region.

Left and right images of FIG. 6 show display screens of the device 100 displaying a window of a first application, and an image in the middle shows a display screen of the device 100 displaying a window of a second application.

In a state where the shield window 601 synchronized with the content is displayed, when the window of the first application is converted to the window of the second application, the device 100 may clear the shield window 601 and display another shield window 602. In detail, the device 100 may acquire shield information of the second application, and display the shield window 602 based on the shield information of the second application.

Also, when the shield window 601 is cleared, the device 100 may store information of the shield window 601 as shield information of the first application, and use the shield information of the first application when the window of the second application is converted again to the window of the first application. In detail, the device 100 may clear the shield window 602 when the window of the second application is converted again to the window of the first application, and display the shield window 601 based on the stored shield information of the first application.

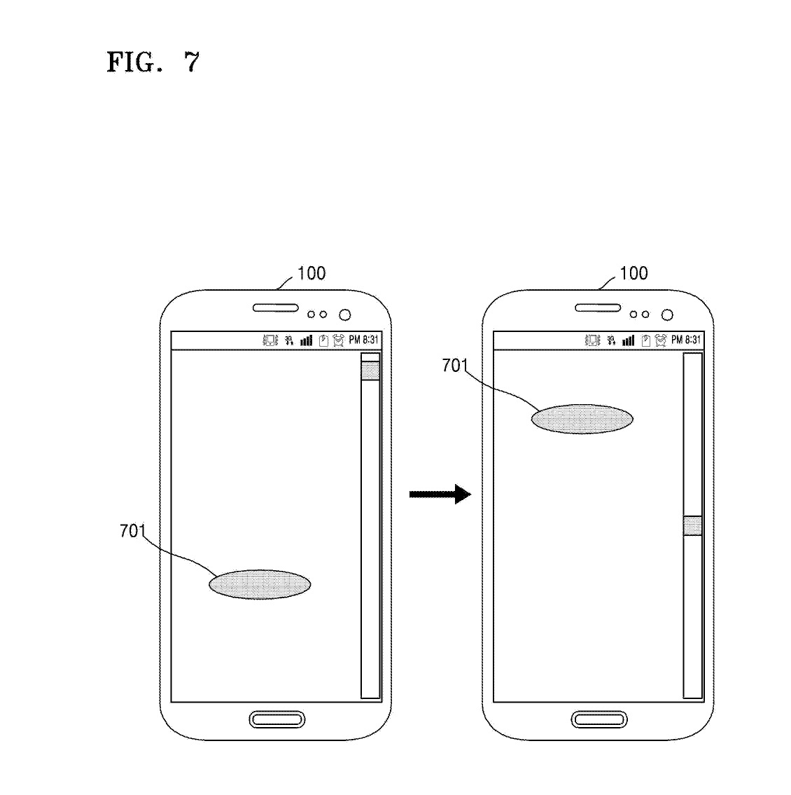

FIG. 7 is a diagram of a shield window 701 that shields all or a region of a display screen on the device 100 of FIG. 6.

Referring to FIG. 7, the device 100 may acquire a shielding operation from the user or shield information of an application, and thus display the shield window 701 for shielding all or a region of a display screen.

In a selected region of the display screen, the device 100 may display the shield window 701 that is synchronized with a content included in all or a portion of the selected region of the display screen.

When a window displayed on the display screen is scrolled, the device 100 may move the shield window 701 along with the content and display the shield window 701. As shown in FIG. 7, when the window displayed on the display screen is scrolled downward, the device 100 may move the shield window 701 in the same speed as the content that is being moved upward. Also, when the window displayed on the display screen is zoomed in or out, the device 100 may zoom in or out of the shield window 701 in the same ratio as the content.

Therefore, the user may continue to shield the content even when scrolling, zooming in on, or zooming out of the window displayed on the display screen.

The device 100 may use various methods to synchronize the shield window 701 and the content or a window of an application.

For example, the device 100 may acquire a snapshot of an original display of a shield region and store the snapshot in shield information of an application. When the user drags a window of the application, the device 100 may acquire direction, force, distance, and other information of the drag operation, and estimate a moving location of the shield region. When the snapshot of the shield region matches an image of the estimated moving location, the device 100 may display the shield window 701 in a matching region.

Alternatively, the device 100 may synchronize the shield window 701 with a content or a window of an application by using Optical Character Recognition (OCR). First, the device 100 may perform character recognition on a shield region by using OCR and store the characters. When the user drags a window of an application, the device 100 may perform character recognition on a whole image of a current display screen by using OCR. The device 100 may use the stored characters in the shield region and display the shield window 701 in a matching region.

According to another example, when the user drags a window of an application, the device 100 may acquire direction, force, distance, and other information of the drag operation, and estimate relative displacement information of the window before and after the drag operation. The device 100 may display the shield window 701 in a corresponding location by using the estimated relative displacement information.

Alternatively, the device 100 may set a reference based on a location of a shield region in a window of an application displayed on a display screen. The device 100 may control such that a motion trajectory of the reference is consistent with that of the shield region, and synchronize the shield window 701 and a content.

By way of another example, an application displayed on a display screen may provide an Application Programming Interface (API) for acquiring a coordinate of a pixel point corresponding to a certain portion of a content displayed on the display screen and acquiring a currently displayed content according to the coordinate of the pixel point. When a shielding operation is requested or input by the user, the device 100 acquires a set of pixel points in the shield region, acquires a content corresponding to the pixel points according to the API, and stores the content. When the window of the application is dragged, the device 100 may search a current display screen according to the API and shield a region corresponding to the content by using the shield window 701. When there is no corresponding region, the device 100 may not display the shield window 701, and search again when another shielding operation is requested.

The device 100 may display the shield window 701 that is synchronized with the content and thus continue to adaptively shield personal information that the user wants to shield or a used content.

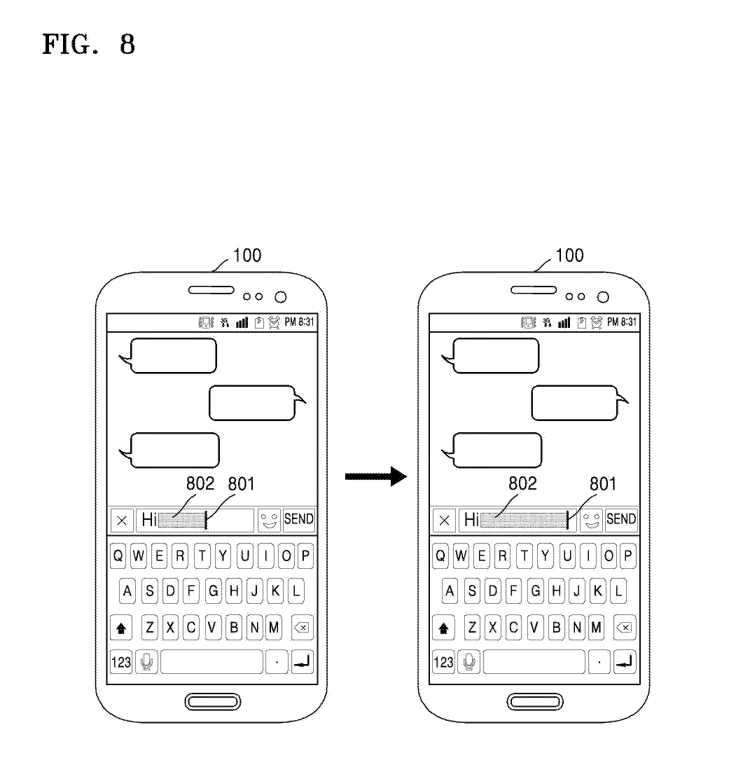

FIG. 8 is a diagram of a shield window 802 that shields all or a region of a display screen on a device 100 according to another exemplary embodiment.

Referring to FIG. 8, the device 100 may acquire a shielding operation (i.e., obtain an input or request for a shielding operation) from a user or shield information of an application, and thus display a shield window 802 for shielding all or a region of the display screen.

The device 100 may acquire an operation of positioning a cursor in a textbox as the shielding operation, and select a region from an initial location of the cursor to a location of a current cursor 801 as a region to be shielded. The device 100 may dynamically select the region to be shielded according to the current cursor 801 that moves as the user inputs characters. The device 100 may display the shield window 802 in the selected region, and the shield window 802 may be increased in size as the user inputs characters.

Also, when a window of an application includes the textbox, the device 100 may acquire shield information of the application and display the shield window 802 for shielding the textbox. The device 100 may select a region from an initial location of the textbox to the location of the current cursor 801 as the region to be shielded, and display the shield window 802 in the selected region.

The user may move the current cursor 801 to another location by using a touch operation or a cursor moving button to identify characters included in a shield region shielded by the shield window 802. When the current cursor 801 is moved to another location according to an additional operation of the user, the device 100 may display the shield window 802 having a different shape according to the other location of the current cursor 801.

In this case, the device 100 may display the shield window 802 that does not affect a normal operation of the shield region. In other words, when the user touches the shield window 802, the device 100 may acquire a touch operation on the shield region that is shielded by the shield window 802. The user may select, copy, or delete characters in the textbox in the same manner as when the shield window 802 is not provided.

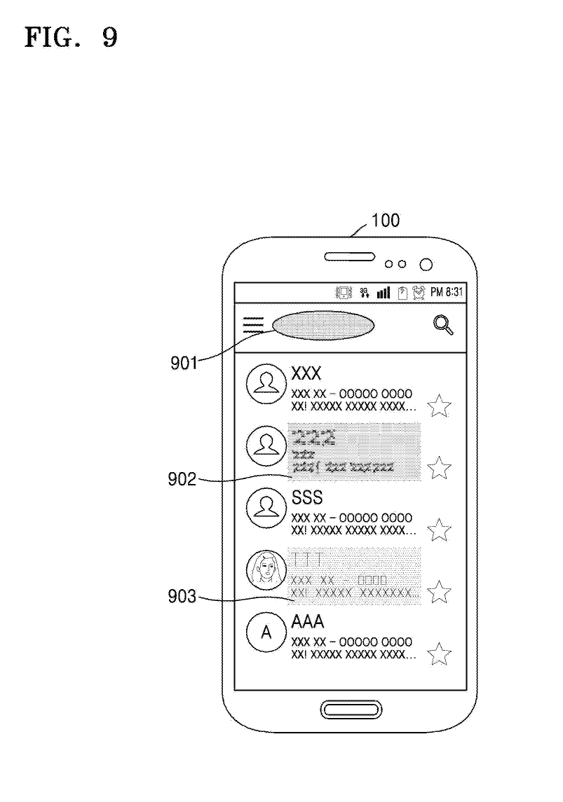

FIG. 9 is a diagram for describing a method of shielding all or a region of a display screen on the device 100 according to an exemplary embodiment.

Referring to FIG. 9, the device 100 may display a predetermined image or an additional shield window to shield a region selected according to a shielding operation of a user or shield information of an application.

Also, in order to shield all or a region of the display screen, the device 100 may modify a display image of a content included in a certain region of the display screen. For example, the device 100 may display the content in a blurry, dark, or transparent manner, or display the content as a mosaic.

FIG. 9 illustrates various shield windows 901, 902, and 903 displayed in all or a region of the display screen of the device 100.

For example, the device 100 may display a first shield window 901 that has a predetermined color and is opaque. The first shield window 901 may be preset by default, or set by the user and have a predetermined color, include an image, and/or include characters.

Alternatively, the device 100 may display a second shield window 902 with a mosaic effect. The second shield window 902 may include a mosaic image of a content in the selected shield region. When the content in the shield region is a dynamic content such as a video, the second shield window 902 may include a dynamic mosaic image.

Alternatively, the device 100 may display a third shield window 903 with a semi-transparent effect. The third shield window 903 may include a hazy image as if the content in the selected shield region is observed through a semi-transparent window. The user may be able to recognize an outline of the content without exposing personal information, and thus may easily use the device 100 in an ordinary manner.

Alternatively, the device 100 may display a shield window with various effects other than the mosaic effect or the semi-transparent effect, for example, a blur or darkening effect.

A shield window may be preset by default or set by the user. The shield window may be set differently according to a type of an executed application, a type of a content in a shield region, or a type of a shielding operation of the user.

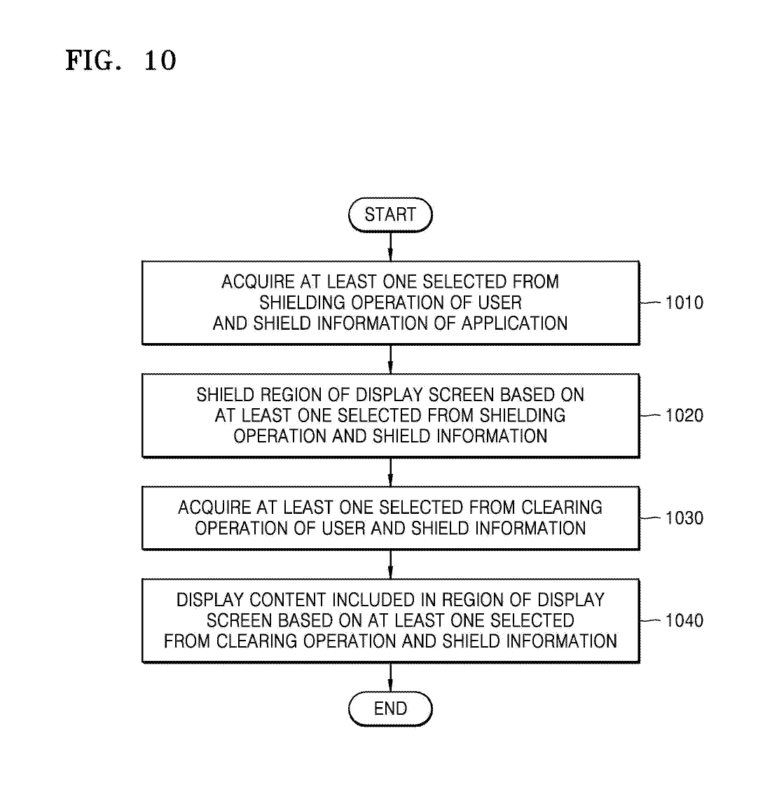

FIG. 10 is a flowchart of a method of shielding all or a region of a display screen on the device 100 according to another exemplary embodiment.

Referring to FIG. 10, in operation 1010, the device 100 may acquire at least one of an operation performed by a user to shield all or a region of the display screen, and shield information of an application.

In operation 1020, the device 100 may shield all or a region of the display screen based on at least one of the acquired shielding operation and the acquired shield information of the application.

The device 100 may select a predetermined region by using at least one of the shielding operation and the shield information of the application, and shield the selected region by displaying a shield window.

In operation 1030, the device 100 may acquire at least one of an operation of the user for clearing a shield on the display screen, and the shield information of the application.

The device 100 may acquire (e.g., receive a request or input of) a clearing operation from the user. For example, the device 100 may acquire the clearing operation by detecting tapping, touching and holding, double tapping, hovering, dragging, or flicking performed by a finger or a stylus of the user.

Also, the device 100 may acquire the clearing operation by detecting an operation of wiping the display screen by using an eraser image on the display screen or an operation of touching a cursor in a textbox. The clearing operation for clearing the shield may be performed on a shield region displayed on the display screen of the device 100.

According to another exemplary embodiment, the device 100 may acquire the clearing operation according to sight focus information acquired by detecting a sight, gaze, or eye focus of the user.

Furthermore, the device 100 may acquire an operation of finishing an executed application as the clearing operation.

The device 100 may acquire shield information of the executed application. The shield information may include a method of clearing a shield on the executed application. For example, the shield information may include at least one of a type of an operation of the user for clearing the shield, shield clearing time, and verification necessary to clear the shield.

In operation 1040, the device 100 may clear the shield (e.g., shield window) in the shield region based on at least one of the acquired clearing operation and the shield information of the application.

The device 100 may select a region (e.g., a clearing region) corresponding to the shield region of the display screen according to at least one of the acquired clearing operation and the shield information, and clear a shield in the selected region.

The device 100 may display a content included in the shield region to clear the shield. When a shield window is displayed in the selected region of the display screen, the device 100 may clear the shield window, and when a display image of a content in the selected region is modified, the device 100 may display the content in a normal state set before the modification.

For example, the device 100 may clear a selected shield window according to a tapping operation on the shield window performed by the user.

Also, the device 100 may display a content included in a portion of a shield region according to an operation, performed by the user, of wiping the shield region or the portion of the shield region.

Also, the device 100 may display a content included in a touch point in the shield region according to an operation, performed by the user, of touching and holding the shield region. The device 100 may dynamically clear a shield as the user moves the touch point. In detail, when the touch point is moved, the device 100 may shield a region including a touch point before the movement, and clear a shield on a region including a touch point after the movement.

According to another exemplary embodiment, the device 100 may change a transparency of the shield according to an input of a user, e.g., dynamically change the transparency according to a dragging operation.

When a region is selected to clear a shield, the device 100 may first perform verification, and clear the shield on the selected region when the verification is successful.

In order to perform the verification, the device 100 may acquire a verification password or a clearing operation, from the user, of drawing a certain (e.g., predetermined or pre-set) shape when selecting all or a region. For example, the device 100 may acquire a clearing operation of drawing a triangle, a quadrilateral, or a circle performed by the user to select all or a region, and determine whether the clearing operation is appropriate by comparing an acquired shape and preset verification information.

The device 100 may clear the shield on the selected region when the acquired clearing operation is appropriate.

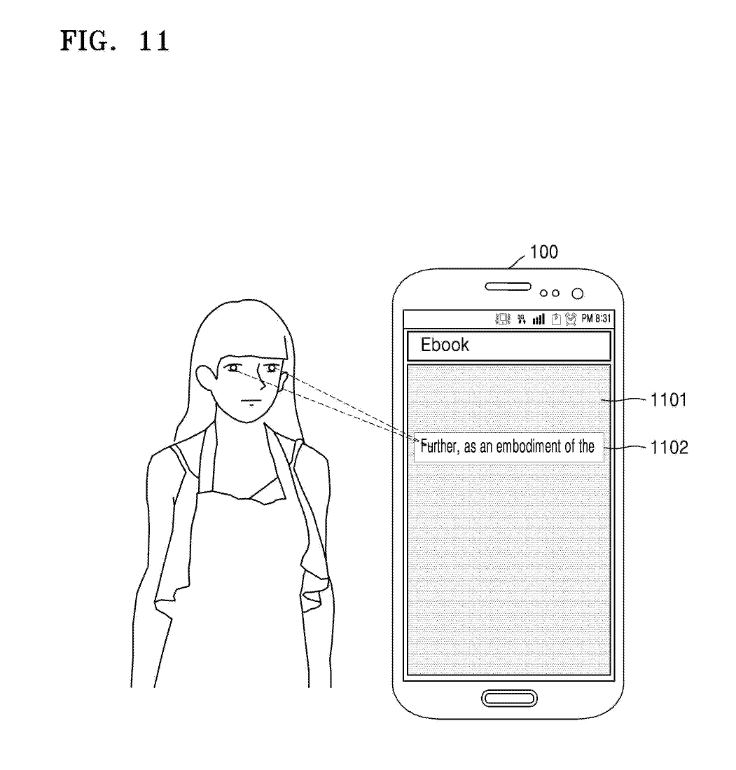

FIG. 11 is a diagram for describing a process of shielding all or a region of a display screen or clearing a shield on the display screen according to the method of shielding all or a region of the display screen of FIG. 10.

Referring to FIG. 11, when a user is reading an electronic book (e-book) by using the device 100, a shield appears on the display screen of the device 100.

The user who is reading the e-book may not desire contents of the e-book to be exposed to others. Therefore, the device 100 may shield all regions including characters on the display screen by using a shield window 1101.

Also, the device 100 may clear a portion that the user wants to read so that the user may read the e-book.

In detail, the device 100 may acquire sight focus information by detecting a sight focus of the user. The device 100 may clear only a shield on a row 1102 (or a predetermined range of rows including the row 1102) including or corresponding to the sight focus by using the acquired sight focus information. The device 100 may dynamically acquire the sight focus information as the sight focus of the user moves, and thus dynamically clear the shield. When the user moves the sight focus, the device 100 may shield the region where the shield had been cleared, and clear a shield on a new row corresponding to the movement of the sight focus.

According to another exemplary embodiment, the device 100 may acquire a touch and hold operation from the user and clear only a shield of the row 1102 (or set of rows) that includes or corresponds to a touch point according to the touch and hold operation. When the touch point of the user moves, the device 100 may shield the region of which the shield was cleared and clear a shield on a new row including a moved touch point to provide a content to the user. When the user completely ends the touch and hold operation on the display screen, the device 100 may shield all regions including characters.

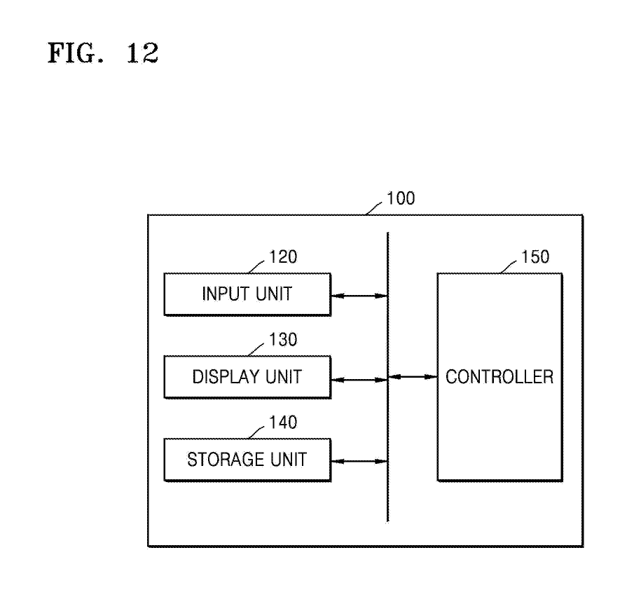

FIG. 12 is a block diagram of an exemplary structure of the device 100 that shields all or a region of the display screen of FIG. 1.

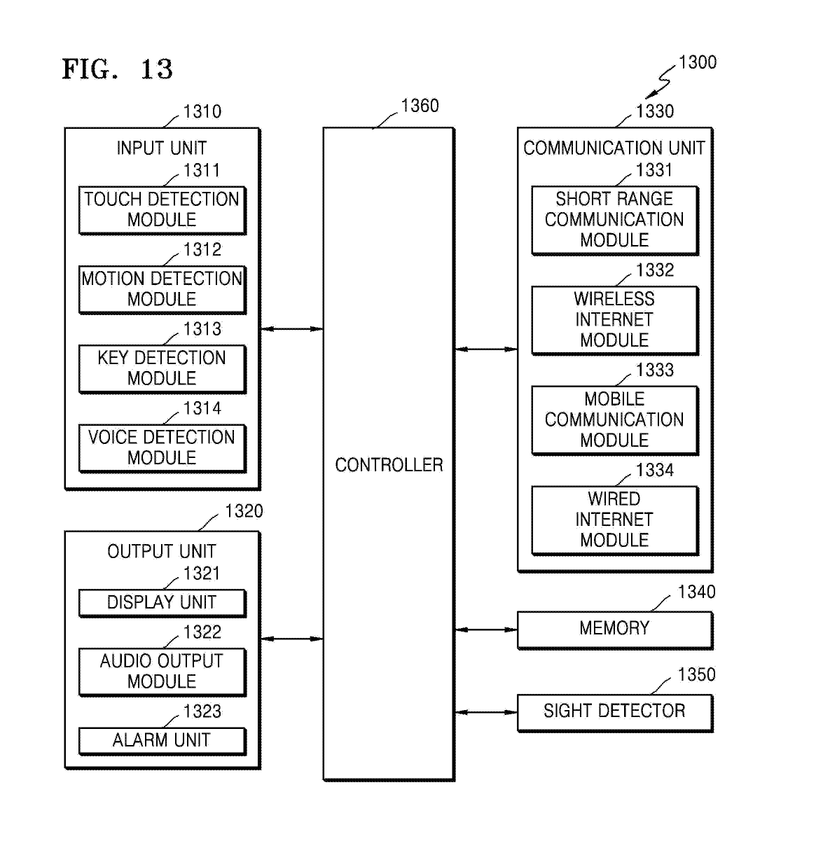

Referring to FIG. 12, the device 100 may include an input unit 120 (e.g., inputter or input device), a display unit 130 (e.g., display), a storage unit 140 (e.g., storage), and a controller 150. FIG. 12 illustrates components related to the present exemplary embodiment to clearly describe the features of the present exemplary embodiment. However, one of ordinary skill in the art may understand that it is possible to additionally include other components (e.g., software or hardware components) other than those illustrated in FIG. 13.

The input unit 120 may be a hardware component for inputting information for controlling the device 100. For example, the input unit 120 may be formed (e.g., provided) as a key pad, a keyboard, one or more physical (e.g., push) buttons, a dome switch, a touchpad, a trackpad, a jog wheel, a jog switch, a joystick, etc.

The input unit 120 may acquire an operation for shielding the display screen from the user. For example, the device 100 may acquire a shielding operation by detecting tapping, touching and holding, double tapping, hovering, dragging, or flicking performed by a finger or a stylus of the user. Alternatively, the device 100 may acquire the shielding operation by detecting an operation of wiping the display screen by using an eraser image displayed on the display screen or an operation of positioning a cursor in a textbox.

The input unit 120 may acquire an additional operation for moving a shield window on the display screen from the user.

The input unit 120 may acquire an operation for clearing a shield on the display screen from the user.

The input unit 120 may receive an operation for verification or a verification password from the user.

The display unit 130 is a hardware component that displays information processed in the device 100. The device 100 may provide a user interface screen to the user via the display unit 130, and provide various applications or contents.

The display unit 130 may shield a region selected by the user to be shielded. In detail, the display unit 130 may shield a display screen of the selected region or a content in the selected region. The display unit 130 may shield the selected region by displaying a shield window on the selected region.

The display unit 130 may synchronously display the shield window with the display screen or the content in the selected region.

When a window displayed on the display screen is modified due to scrolling, the display unit 130 may modify the shield window according to a modification of the content. For example, when the content is scrolled, zoomed out, or zoomed in, the display unit 130 may scroll the shield window in the same speed as the content or zoomed in or out of the shield window in the same ratio as the content.

The display unit 130 may clear a shield of a region selected from the shield region on the display screen by the user to clear the shield. For example, when the shield window is displayed on the shield region of the display screen, the display unit 130 may clear the shield window, and when a display image of a content in the selected region is modified, the display unit 130 may display the content in a normal state set before the modification.

When the controller 150 performs verification, the display unit 130 may display a verification result that shows whether the verification is successful.

The storage unit 140 is a hardware component for storing information used in the device 100 and may be a Hard-Disk Drive (HDD), a Solid State Drive (SSD), a Random Access Memory (RAM), or a Read-Only Memory (ROM).

The storage unit 140 may store shield information of an application executed in the device 100.

The shield information includes a shield state of the display screen with respect to a window of a displayed application. In detail, the shield information may include a method of completely or partially shielding the display screen, a method of clearing a shield, and an object to be synchronized with a shield window. For example, based on the shield information, the device 100 may shield the display screen by determining an extent and a location of a shield region, a shape of the shield window, and a shielding time, which correspond to the window of the application.

The storage unit 140 may store the shield information of the application by default or store shield information set by the user.

When the window of the application is converted, the storage unit 140 may store a shield state of the window of the application before the conversion as the shield information.

The controller 150 is a hardware component that includes at least one processor, such as a Central Processing Unit (CPU) or an application processor (AP), and controls operations of the device 100.

The controller 150 may shield all or a region of the display screen based on at least one of the acquired shielding operation and the shield information of the application.

In detail, the controller 150 may select a region of the display screen based on at least one of the acquired clearing operation and the shield information, and control the display unit 130 such that the selected region is shielded.

The controller 150 may select all or a region of the display screen as a region to be shielded. Furthermore, the controller 150 may select a plurality of regions.

The controller 150 may shield all or a region of the display screen by controlling the display unit 130 such that the shield window (such as a predetermined image) is displayed on the selected region. Also, the controller 150 may modify a display image of a content in the selected region so that a modified image is displayed by the display unit 130.

The controller 150 may synchronize the shield window for shielding the display screen with the display screen or the content in the selected region of the display screen.

By way of example, the controller 150 may synchronize the shield window with the content in the selected region of the display screen by using snapshot matching, OCR, relative location information, or an API.

The controller 150 may select a region corresponding to the shield region of the display screen according to the acquired clearing operation or the acquired shield information, and control the display unit 130 so that the shield on the selected region is cleared. For example, the controller 150 may select a region corresponding to a sight focus based on sight focus information acquired from the user, and clear the shield.

When a clearing operation of the user for clearing the shield or the shield information is acquired, the controller 150 may verify the acquired clearing operation or the acquired shield information. When the verification is successful, the controller 150 may control the display unit 130 such that the shield on the selected region is cleared.

FIG. 13 is a block diagram of another exemplary structure of a device 100 that shields all or a region of the display screen of FIG. 1.

Referring to FIG. 13, the device 100 may include an input unit 1310 (e.g., inputter or input device), an output unit 1320 (e.g., outputter or output device), a communication unit 1330 (e.g., communicator), a memory 1340, a sight detector 1350, and a controller 1360. The input unit 1310 may include a touch detection module 1311 (e.g., touch detector), a motion detection module 1312 (e.g., motion detector), a key detection module 1313 (e.g., key detector), and a voice detection module 1314 (e.g., voice detector). The output unit 1320 may include a display unit 1321 (e.g., display), an audio output module 1322 (e.g., audio outputter or audio output device), and an alarm unit 1323 (e.g., alarm or alarm device). The communication unit 1330 may include a short range communication module 1331 (e.g., short range communicator), a wireless Internet module 1332 (e.g., wireless network adapter, interface, or transceiver), a mobile communication module 1333 (e.g., mobile communicator), and a wired Internet module 1334 (e.g., wired network adaptor, interface, or transceiver). FIG. 13 illustrates components related to the present exemplary embodiment to clearly describe the features of the present exemplary embodiment. However, one of ordinary skill in the art may understand that it is possible to additionally include hardware or software components other than those illustrated in FIG. 13 or omit some of the components illustrated in FIG. 13.

The input unit 1310 may be a hardware component for inputting information for controlling the device 100. For example, the input unit 1310 may be formed as a key pad, a dome switch, a touchpad, a jog wheel, a jog switch, etc.

The touch detection module 1311 may detect a touch gesture or a touch input of a user, and transmit information regarding the detected touch gesture or the detected touch input to the controller 1360.

The touch detection module 1311 may include various sensors for detecting a touch or a proximity touch. In order to detect the touch gesture or the touch input, the touch detection module 1311 may be formed (e.g., provided) as a capacitive sensor, a resistive sensor, an infrared sensor, an integral strain gauge sensor, a surface acoustic wave sensor, a piezoelectric sensor, etc.

Also, the touch detection module 1311 may detect a proximity touch by using a proximity sensor. The proximity sensor is a sensor that may detect the presence of an object approaching or nearby a predetermined detection surface by using electromagnetic force or infrared rays without mechanical contact. Examples of the proximity sensor include a penetration-type photoelectric sensor, a direct-reflective photoelectric sensor, a mirror-reflective photoelectric sensor, a high frequency oscillation proximity sensor, a capacitive proximity sensor, a magnetic proximity sensor, an infrared proximity sensor, etc.

The touch gesture or the touch input of the user may include tapping, touching and holding, double tapping, hovering, dragging, or flicking.

The touch detection module 1311 may form a multi-layer structure with the display unit 1321 and be provided as a touch screen. In other words, the display unit 130 of FIG. 12 may be provided as a hardware structure, i.e., a touch screen that includes the touch detection module 1311 and the display unit 1321.

The motion detection module 1312 may detect motions of the device 100 and transmit information regarding the motions of the device 100 to the controller 1360. For example, the motion detection module 1312 detects three-dimensional (3D) motions or rotations when the device 100 moves, not a modification of the device 100.

The motion detection module 1312 may include various sensors for detecting the motions of the device 100. For example, the motion detection module 1312 may include an acceleration sensor, a tilt sensor, a gyro sensor, a three-axis magnetic sensor, etc.

A motion input that may be detected by the motion detection module 1312 may include a 3D motion input generated when the device 100 is moved to an X-axis, a Y-axis, or a Z-axis direction, a rotation input generated when the device 100 is rotated to at least one direction is the 3D space, a shake input generated when the device 100 shakes in at least one direction, and a tilt input generated when the device 100 is tilted to a predetermined direction.

The key detection module 1313 may detect a command that is input via a hardware key (for example, arrow keys, letter keys, or a mouse) by the user. The voice detection module 1314 may detect voice of the user by using a voice detection engine, and transmit the detected voice to the controller 1360.

The output unit 1320 is a hardware component for outputting an audio signal, a video signal, or an alarm signal.

The display unit 1321 is a display interface unit for displaying various types of information, for example, information processed or to be processed by the device 100, to the user. The display unit 1321 may display a Graphical User Interface (GUI) so that the information processed by the device 100 is visually and intuitively perceived by the user. The display unit 1321 may perform the functions of the display unit 130 described with reference to FIG. 12. The display unit 130 of FIG. 12 may be provided as a hardware structure, i.e., a touch screen that includes the touch detection module 1311 and the display unit 1321.

The audio output module 1322 may output audio data received via the communication unit 1330 or stored in the memory 1340. The audio output module 1322 may include a speaker or a buzzer.

The alarm unit 1323 may output a signal to notify an event occurring in the device 100. The alarm unit 1323 may output a signal for notifying an event by using at least one selected from an audio signal, a video signal, and a vibration signal.

The communication unit 1330 is a hardware component that may communicate with an external network or an external device.

The short range communication module 1331 is a module for communicating within a short range. The short range communication technology may include Bluetooth, Ultra Wideband (UWB), ZigBee, Near Field Communication (NFC), Wi-Fi Direct (WFD), infrared Data Association (IrDA), etc.

The wireless Internet module 1332 is a module for accessing wireless Internet. The mobile communication module 1333 is for communicating with a mobile communication network. The wired Internet module 1334 is a module for accessing wired Internet.

The memory 1340 is a hardware component for storing information processed by the device 100 and may be a HDD, a SDD, a RAM, or a ROM. For example, the memory 1340 may store information regarding a user interface that is to be displayed via the display unit 1321.

The sight detector 1350 is a hardware component that detects a viewing direction of the user that is watching the display unit 1321 of the device 100, and may be formed as a module such as an infrared camera or a proximity sensor. The sight detector 1350 may detect the viewing direction by detecting an eye direction or a front face direction of the user. The sight detector 1350 may not only detect the viewing direction, but also estimate a distance between the display unit 1321 and the user.

The controller 1360 is a hardware component that controls operations and functions of the device 100, and may be formed by using at least one processor, such as a CPU or an AP. The controller 150 of FIG. 2 may correspond to the controller 1360.

As described above, according to one or more exemplary embodiments, a device for shielding all or a region of a display screen may prevent an exposure of personal information and private contents such as images and videos of a user. Also, the device may prevent the exposure of private contents, and simultaneously, provide ordinary functions so that the user may normally use the device. In addition, harmful information, disruptive information, and unnecessary information such as an advertisement may be prevented so that a comfortable environment is provided to the user.

The device described herein may include a processor, a memory for storing program data executable by the processor, a permanent storage unit such as a disk drive, a communication port for handling communications with external devices, and user interface devices, including a touch panel, keys, buttons, etc. When software modules or algorithms are involved, these software modules may be stored as program instructions or computer readable codes executable on a processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributive manner. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting understanding of the principles of the inventive concept, reference has been made to exemplary embodiments illustrated in the drawings, and specific language has been used to describe these exemplary embodiments. However, no limitation of the scope of the inventive concept is intended by this specific language, and the inventive concept should be construed to encompass all exemplary embodiments that would normally occur to one of ordinary skill in the art.

Exemplary embodiments may be described in terms of functional block components and various processing steps. Such functional blocks may be realized by any number of hardware and/or software components configured to perform the specified functions. For example, an exemplary embodiment may employ various integrated circuit (IC) components, e.g., memory elements, processing elements, logic elements, look-up tables, and the like, which may carry out a variety of functions under the control of one or more microprocessors or other control devices. Similarly, where the elements are implemented using software programming or software elements, an exemplary embodiment may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, an exemplary embodiment could employ any number of related art techniques for electronics configuration, signal processing and/or control, data processing and the like. The words “mechanism,” “element,” “means,” and “configuration” are used broadly and are not limited to mechanical or physical embodiments, but can include software routines in conjunction with processors, etc.

The particular implementations shown and described herein are illustrative examples of exemplary embodiments and are not intended to otherwise limit the scope of the inventive concept in any way. For the sake of brevity, related art electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of exemplary embodiments unless the element is specifically described as “essential” or “critical.”

The use of the terms “a,” “an,” “the,” and similar referents in the context of describing the inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. An exemplary embodiment is not limited to the described order of the steps. The use of any and all examples, or exemplary language (e.g., “such as”) provided herein, is intended merely to better illuminate exemplary embodiments and does not pose a limitation on the scope of the inventive concept unless otherwise claimed. Numerous modifications and adaptations will be readily apparent to one of ordinary skill in the art without departing from the spirit and scope.

What is claimed is:

1. A method of shielding a region of a display screen in a device, the method comprising:
acquiring at least one of shield information of an application executed in the device, and a shielding operation performed by a user to shield the region of the display screen; and
shielding the region of the display screen based on the acquired at least one of the shield information and the shielding operation.

2. The method of claim 1, wherein the shielding the region of the display screen comprises:
selecting a region of the display screen according to the acquired at least one of the shield information and the shielding operation; and
shielding the selected region.

3. The method of claim 2, wherein the shielding the selected region comprises shielding a display image corresponding to the selected region.

4. The method of claim 3, wherein the shielding the display image corresponding to the selected region comprises displaying a shield window, which is fixedly synchronized with the display screen, on the selected region.

5. The method of claim 4, wherein the shield window is moved within the display screen based on an operation of the user.

6. The method of claim 2, wherein the shielding the selected region comprises shielding a content comprised in the selected region.

7. The method of claim 6, wherein the shielding the content comprises displaying a shield window for shielding the content, which is synchronized with the content, on the selected region.

8. The method of claim 1, wherein the shielding the region of the display screen comprises modifying a display image of the region on the display screen.

9. The method of claim 1, further comprising:
acquiring at least one of the shield information and a clearing operation performed by the user to completely or partially clear a shield region of the display screen; and
displaying a content comprised in all or a portion of the shield region of the display screen based on the acquired at least one of the shield information and the clearing operation.

10. The method of claim 9, wherein the displaying the content comprises:
selecting a clearing region from the shield region of the display screen, based on the acquired at least one of the clearing operation of the user and the shield information; and
displaying a content comprised in the selected clearing region.

11. A non-transitory computer-readable recording medium having recorded thereon a program, which, when executed by a computer, performs the method of claim 1.

12. A device for shielding a region of a display screen, the device comprising:
an input unit configured to acquire at least one of shield information of an application executed in the device, and a shielding operation performed by a user to shield the region of the display screen;
a controller configured to select the region of the display screen based on the acquired at least one of the shield information and the shielding operation; and
a display configured to shield the selected region.

13. The device of claim 12, wherein the display is further configured to shield a display image corresponding to the selected region.

14. The device of claim 13, wherein the display is further configured to display a shield window, which is fixedly synchronized with the display screen, on the selected region.

15. The device of claim 14, wherein the shield window is moved within the display screen based on an operation of the user.

16. The device of claim 12, wherein the display is further configured to shield a content comprised in the selected region.

17. The device of claim 16, wherein the display is further configured to display a shield window for shielding the content, which is synchronized with the content, on the selected region.

18. The device of claim 12, wherein:
the input unit is further configured to acquire at least one of the shield information and a clearing operation performed by the user to completely or partially clear a shield region of the display screen;
the controller is further configured to select a clearing region from the shield region of the display screen, based on the acquired at least one of the shield information and the clearing operation of the user; and
the display is further configured to display a content comprised in the selected clearing region.

19. The device of claim 18, wherein:
the controller is further configured to verify the acquired at least one of the shield information and the clearing operation; and
the display is further configured to display the content when the verification is successful.

20. The device of claim 18, wherein:
the input unit is further configured to acquire sight focus information of the user; and
the controller is further configured to select the clearing region as a region corresponding to a sight focus of the user based on the acquired sight focus information of the user.

21. A device for shielding a region of a display screen, the device comprising:
a controller configured to:
select the region of the display screen based on an acquired at least one of shield information of an application executed in the device, and a shielding operation performed by a user to shield the region of the display screen; and
shield the selected region of the display screen and output the display screen in which the selected region is shielded.

22. The device of claim 21, wherein the controller is further configured to shield a display image, of the display screen, corresponding to the selected region.

23. The device of claim 22, wherein the controller is further configured to output a shield window, which is fixedly synchronized with the display screen on the selected region.

24. The device of claim 23, wherein the shield window is moved within the display screen based on an operation of the user.

25. The device of claim 21, wherein the controller is further configured to shield a content comprised in the selected region.

26. The device of claim 25, wherein the controller is further configured to output a shield window for shielding the content, which is synchronized with the content in the selected region.

27. The device of claim 21, wherein the controller is further configured to:
select a clearing region from the shield region of the display screen, based on an acquired at least one of the shield information and a clearing operation performed by the user to completely or partially clear a shield region of the display screen; and
control to output for display a content comprised in the selected clearing region.

28. The device of claim 27, wherein the controller is further configured to:
verify the acquired at least one of the shield information and the clearing operation; and
control to output for display the content when the verification is successful.

29. The device of claim 27, wherein the controller is further configured to select the clearing region as a region corresponding to a sight focus of the user based on acquired sight focus information of the user.
